(19) United States
(12) Patent Application Publication
(10) Pub. No.: US 2026/0313519 A1
(43) Pub. Date: Oct. 8, 2026

(54) METHOD AND APPARATUS FOR PEGC UNABLE TO SERVE PERSONAL IOT NETWORK (PIN)

(71) Applicant: InterDigital Patent Holdings, Inc., Wilmington, DE (US)

(72) Inventors: Anuj SETHI, Ottawa (CA); Michael STARSINIC, Newtown, PA (US); Michel ROY, Candiac (CA); Debashish PURKAYASTHA, Eagleville, PA (US)

(73) Assignee: InterDigital Patent Holdings, Inc., Wilmington, DE (US)

(21) Appl. No.: 19/478,308

(22) PCT Filed: May 10, 2024
(86) PCT No.: PCT/US2024/028866

§ 371 Date: Oct. 24, 2025

Related U.S. Application Data
(60) Provisional application No. 63/465,715, filed on May 11, 2023.

(51) Int. Cl. H04W 48/06; H04W 48/16; H04W 60/00

(52) U.S. Cl. CPC H04W 48/06; H04W 48/16; H04W 60/001

(57) ABSTRACT

Methods and devices are disclosed for a wireless transmit and receive unit (WTRU) to manage its serving as a personal Internet-of-things network (PIN) element with Gateway Capability (PEGC) when network connection becomes unavailable. In response to Non access stratum (NAS) signaling received indicating unavailability of connection to a 5G network, the WTRU is triggered to respond with NAS signaling indicating information elements such as the WTRU is a PEGC and a PIN ID. The response may be a de-registration message, PDU session release message, uplink transport message registration or a registration for network slice selection assistance information (NSSAI) excluding a single slice (S-NSSAI) associated with the PDU session. The information elements may include reasons the WTRU cannot serve as PEGC, a time of expected unavailability, the PIN ID and other information.

### CROSS-REFERENCE TO RELATED APPLICATIONS

This application claims the benefit of U.S. Provisional Application No. 63/465,715, filed May 11, 2023, the contents of which is incorporated herein by reference.

### BACKGROUND

A personal IoT network (PIN) is a configured and managed group of PIN elements able to communicate with each other directly or via PIN Elements with Gateway Capability (PEGC). PINs may communicate with a 5G network via at least one PEGC, and managed by at least one PIN Element with Management Capability (PEMC). A PIN element (PINE) is a wireless transmit receive unit (WTRU) such as user equipment (UE) or non-3GPP device that can communicate within a PIN (via PIN direct connection, via PEGC, or via PEGC and 5GC), or outside the PIN via a PEGC and 5G core network (5GC). A PIN Element with Gateway Capability (PEGC) is a PIN Element with the ability to provide connectivity to and from the 5G network for other PIN Elements, or to provide relay for the communication between PIN Elements. PIN Element with Management Capability (PEMC) is a PIN Element with capability to manage the PIN.

With the support of the PEGC registered to a 5G network, the PIN Elements have access to the 5G network services and may communicate with other PIN Elements via the 5GC. PIN and PIN elements are managed by a PIN element with Management Capability (PEMC) and may also be managed by an application function (AF). An AF for a PIN may be deployed to support the PIN service. The AF for a PIN may communicate with a PEMC and PEGC(s) via application layer signaling which is transported as user plane data transparently to 5GS. The purpose of the application layer signaling may be for management of the PIN.

The PEGC is a WTRU with subscription data related to a PIN associated with the 5GS, and may register to the 5GS. In some instances, a PEGC serving the PIN might not be able to serve the PIN because it may not be able to provide data connectivity to the external DN. The PEGC may not be able to service the PIN because of an unsuccessful registration or because other non-access stratum (NAS) procedures were unsuccessful, e.g., Session Management (SM) procedures such as PDU Session Establishment or Mobility Management (MM) procedures such as Registration or Service Request.

The procedures may be considered unsuccessful because due to the WTRU's reception of a rejection message from the network. Some of the possible rejection cause codes that may be received by the WTRU from the network may indicate situations such as: congestion, maximum number of PDU sessions reached, insufficient resources for a specific network slice and/or data network name (DNN), insufficient user-plane resources for the PDU session, payload was not forwarded by the mobility management layer, network slice-specific authentication and authorization has failed or the authorization has been revoked, partially rejected/allowed network slices, or rejected slices/requested slice is not part of allowed slices provided by the 5GS.

System enhancements are desired to handle the PIN elements traffic in situations while the PEGC serving the PIN is rejected by the 5GS, due to congestion or other causes, which make the PEGC unable to provide the data path for the PIN traffic.

### SUMMARY

According to some aspects, methods and devices for WTRU actions for the case of a PEGC unable to serve a PIN are disclosed. In other aspects, methods and devices for one or more network functions handling PEGC inability to serve a PIN are disclosed. As used herein, the Fifth Generation of Mobile Telephony, or 5G, or 5GS, is the system defined by 3GPP since Release 15, however the embodiments are not so limited.

According to some aspects, a wireless transmit and receive unit (WTRU) registers as a personal Internet-of-things network (PIN) element with Gateway Capability (PEGC) with a wide-area wireless network (WWAN). Data flows are served between PIN elements and the WWAN. The WTRU receives an indication of unavailability of data flows with the WWAN and sends a non-access stratum (NAS) response including information elements to the network indicating a reason the WTRU can no longer act as PEGC for the PIN and a PIN identification (ID).

In certain examples, the PEGC (WTRU) on reception of the reject from the 5GS, may trigger a deregistration procedure toward the 5GS, providing new information elements about the unavailability of the PEGC, along with the PIN identifier i.e. PIN ID.

An application management function (AMF), on reception of the new information elements from the PEGC about its unavailability, may inform an application function (AF) for the PIN about the PEGC being unable to serve the PIN. The AF for the PIN will take into consideration unavailability of the PEGC as provided by the 5GS, take appropriate actions, such as reconfiguring the PIN with a new PEGC, service switch and continuity via the new PEGC, instruct the PEMC over the user plane to trigger PEGC discovery and selection.

In one example aspect, the AMF, on reception of the new information elements from the PEGC about its unavailability, may inform the PEMC associated with the provided PIN ID of the same.

The PEGC, on reception of the reject cause #22 congestion (rejected due to general NAS level mobility management congestion control), may trigger the public land mobile network (PLMN)/stand-alone non-public network (SNPN) selection to find a suitable and available PLMN/SNPN, which are not congested and could provide normal services.

The PEGC, on becoming aware that the desired slices are not valid anymore (rejected/not part of allowed network slice selection assistance information (NSSAI), etc.), may trigger slice-based PLMN selection if the PEGC has information on the slice specific prioritized list of PLMNs from the home network. Alternatively, the PEGC may send assistance information to the home network providing desired/rejected slices to the home network and the home network may use the assistance information provided by the PEGC to generate a slice-based prioritized list of PLMNs and provide the same to the PEGC via NAS signaling.

According to one example aspect, a service management function (SMF), on rejecting or on becoming aware that PEGC is unable to serve the PIN, may inform the PEMC by extension of existing or new information elements about the PEGC unavailability. The PEMC will take into consideration the unavailability of the PEGC, take appropriate actions, for example, reconfiguring the PIN with a new PEGC, service switch and continuity via the new PEGC, and inform the AF for the PIN, via the User Plane about the re-configuration. Additional features, aspects and embodiments are disclosed.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram of an example personal Internet of things (IoT) network (PIN) architecture;

FIG. 3 is a diagram showing an example home automation PIN;

FIG. 4 is diagram showing an example wearable PIN;

FIG. 5 is a block diagram showing a PIN application (PINAPP) architecture of example embodiments;

FIG. 6 is a messaging sequence diagram of wireless transmit and receive unit (WTRU) actions when a node, referred to as a PIN Elements with Gateway Capability (PEGC), is unable to serve a PIN according to example embodiments;

FIG. 7 is a messaging sequence diagram of network function, e.g., access and mobility management function (AMF) and service management function (SMF), actions when a PEGC is unable to serve a PIN according to example embodiments;

FIG. 8 is a flow chart showing a method of WTRU handling PEGC unavailability according to an embodiment.

FIG. 9 is a flow chart showing a method of network handling PEGC unavailability according to an embodiment.

### DETAILED DESCRIPTION

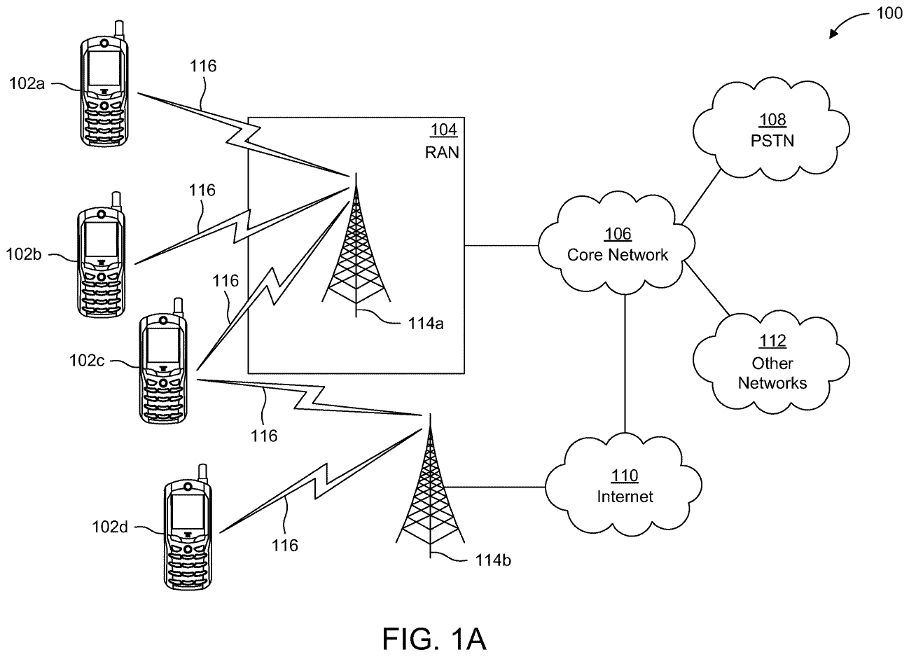

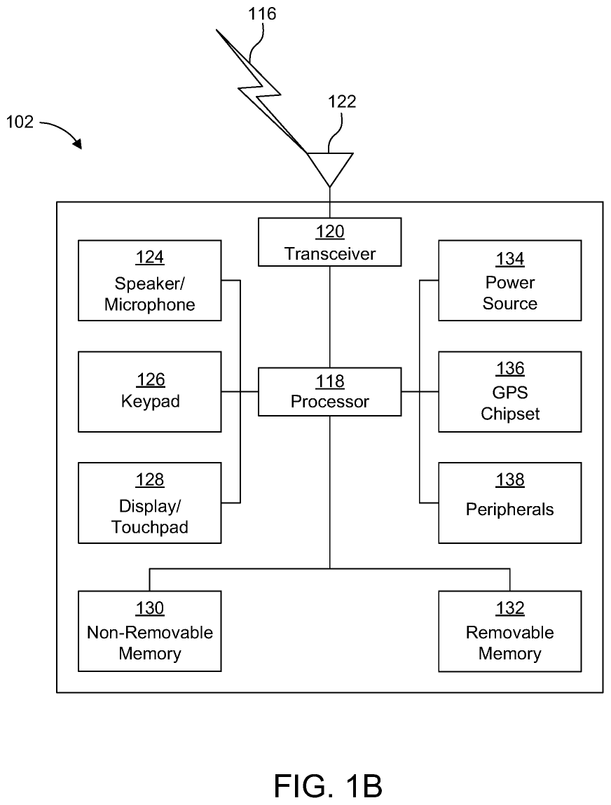

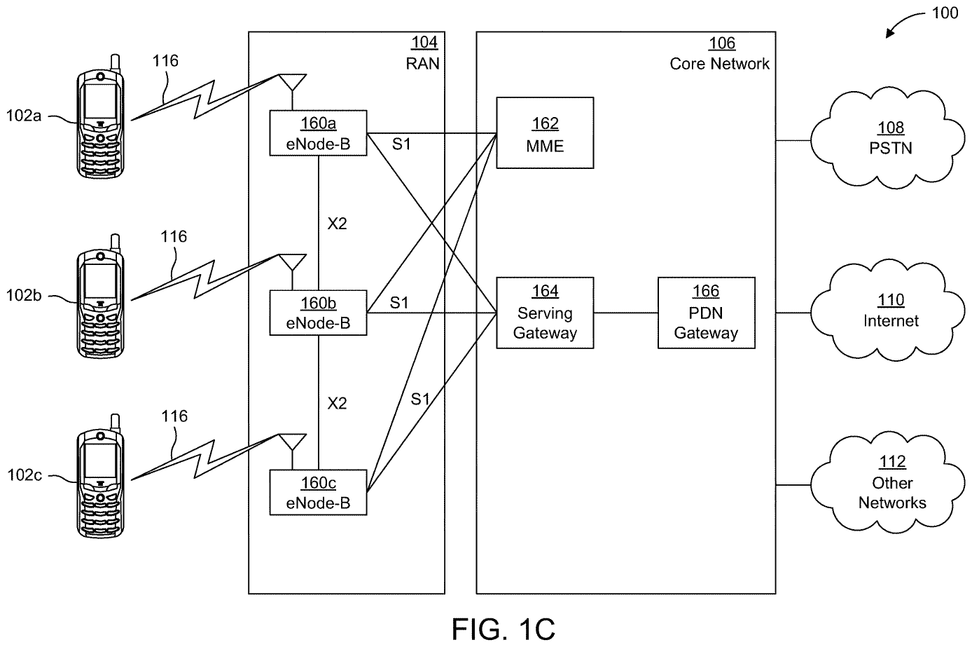

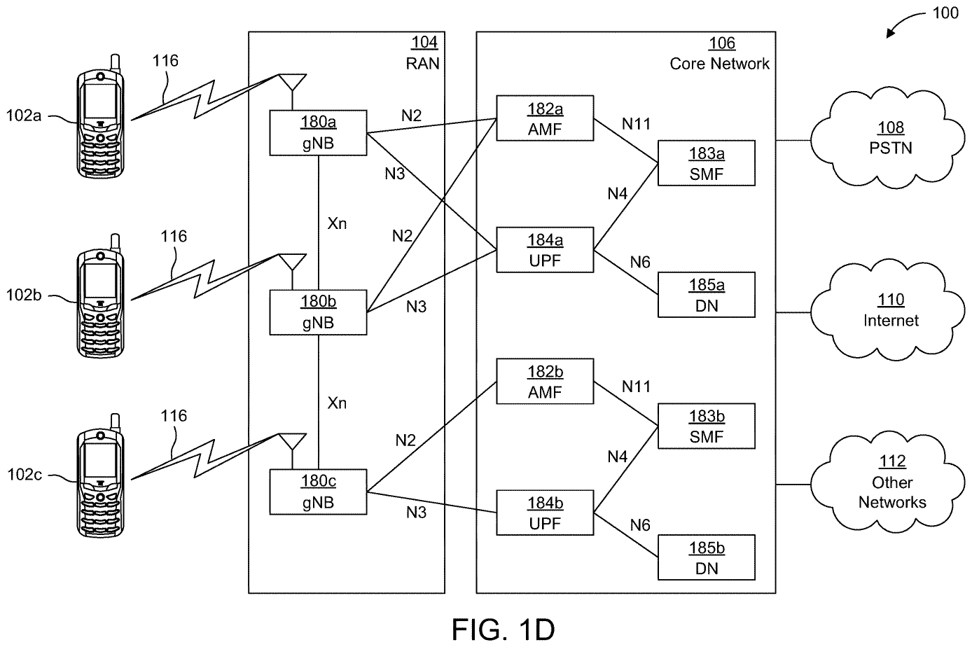

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

As used describing example embodiments herein, the following terms have the associated meaning shown. It should be recognized that embodiments are described merely as examples and their associated terms are not intended to limit embodiments to any specific architecture where similar advantages may be obtained using different elements, functions and/or network architectures.

Personal IoT Network (PIN): A configured and managed group of PIN Element(s) that are able to communicate with each other directly, communicate with each other via PIN Element(s) with Gateway Capability (i.e. PEGC(s), or use a PEGC to communicate with devices or servers that are outside of the PIN via the 5G network. A PIN includes at least one PEGC and is managed by PIN Element(s) with Management Capability (i.e. PEMC(s)). PIN management may be achieved with the support by an AF if AF is deployed.

PIN Element (PINE): A WTRU, UE or non-3GPP device that can communicate within a PIN (via PINE-to-PINE direct connection or PINE-to-PINE indirect connection), or outside the PIN via a PINE with gateway capability (PEGC) and a network, e.g., 5GC.

PIN Element with Gateway Capability (PEGC): A PIN Element with the ability to provide data network (DN) connectivity via the 5G network for other PIN Elements and/or is able to provide relay functionality for communication between PIN Elements. Only a WTRU or UE is able to function as a PEGC by registration to the 5GS.

PIN Element with Management Capability (PEMC): A PIN Element with capability to manage the PIN.

PIN-to-DN communication: the connection between PINE, PEMC and DN via a PEGC and user plane function (UPF) and between PEGC and DN via a UPF.

PIN direct communication: The connection between two PIN Elements, between a PIN Element and a PEGC, between a PIN Element and a PEMC, between a PEMC and a PEGC or between two PEGCs without traversing an intermediate PIN element, any 3GPP radio access network (RAN) or UPF in the middle.

PIN indirect remote communication: the connection between two PIN Elements, between a PIN Element and a PEGC, between a PIN Element and a PEMC, or between a PEMC and a PEGC via the PEGC and UPF.

PINE-to-PINE routing: the traffic is routed by a PEGC between two PINEs, the two PINEs direct connect with the PEGC via non-3GPP access.

PINE-to-Network routing: the traffic is routed by a PEGC between a PINE and the 5GS, the PINE may connect directly with the PEGC via non-3GPP access separately.

Network local switch for PIN: the traffic is routed by UPF(s) between two PINEs, the two PINEs direct connect with two PEGCs via non-3GPP access separately.

As described in the example embodiments, functionality that is described as part of a PINE may be implemented in a PIN Client. Additionally, functionality that is described as part of a PEGC may be implemented in a PIN Gateway Client. Functionality that is described as part of a PEMC may be implemented in a PIN Management Client. Functionality that is described as part of a PIN Client may performed by other functions of a PINE. Functionality that is described as part of a PIN Gateway Client may performed by other functions of a PEGC, and functionality that is described as part of a PIN Management Client may performed by other functions of a PEMC.

Embodiments for WTRU actions when a PEGC is unable to serve the PIN include, the PEGC, on reception of a NAS reject message from the AMF, will trigger a second NAS message toward the AMF. The PEGC will provide new information elements (IEs) in the second NAS message that indicate that the WTRU is a PEGC, that the WTRU will be unavailable, and a corresponding PIN Identification (PIN ID). This new information element or information elements, will inform the AMF that the WTRU being rejected is a PEGC serving a particular PIN identified by PIN ID.

In some embodiments, the second NAS message that carries the new information elements may be a De-Registration message, a PDU Session Release message that is associated with the PDU Session that serves the PIN, a Registration Request and the Requested network slice selectin assistance information (NSSAI) of the Registration Request may not include the single (S-NSSAI) that is associated with the PDU Session that serves the PIN, or an UL Transport message.

In some embodiments, the message that carries the new information elements may be triggered by any of, reception of a NAS message with a rejection cause code; local configuration (e.g., a user configures the WTRU to indicate that it should no longer serve the PIN or act as a PEGC); leaving a geographical area that is associated with the PIN, or entering a geographical area that is not associated with the PIN.

According to various embodiments, the new information elements may indicate any of: a reason that the WTRU can no longer act a PEGC for the PIN (e.g., an indication what triggered the message); how long the WTRU is expected to be unavailable to server the PIN (e.g., this may be based on back-off timer value that was receive from the network); the identity of the PIN that the WTRU can no longer act for as a PEGC; an indication of whether or not the WTRU will continue to act as a gateway for routing local traffic in the PIN; and/or a type of service e.g. mission critical, streaming, multimedia, interactive etc., along with respective status such as active/paused/inactive. In certain embodiments, the NAS layer will send a notification to the PEGC client informing the PDU session has been terminated.

Embodiments for network functions, such as AMF/SMF action when a PEGC is unable to serve a PIN may include the following steps. In one embodiment, a service management function (SMF) receives an indication that a PDU Session of a first WTRU is associated with a PIN. The SMF determines to perform a PDU Session Release procedure for the PDU Session. Determining to perform a PDU Session Release may be based on receiving a PDU Session Release message from the first WTRU. The PDU Session Release message from the first WTRU may indicate the PDU Session that is associated with PIN and may indicate that PIN ID.

In one embodiment, the SMF receives the identity of a second WTRU and information indicating that the second WTRU is the PEMC of the PIN. At reception of a NAS message with cause “not available” and WTRU being identified as a PEGC, the identity of the second WTRU may be obtained by the SMF querying the unified data management (UDM)/unified data repository (UDR) and providing the PIN ID in the query request. The SMF then sends, to the second WTRU, a message that includes an indication that the PDU Session of the first WTRU is not available. In some embodiments, this message may indicate a reason why the PDU Session of the first WTRU is not available. Examples of the reason may indicate congestion, that the WTRU is not in a service area, that the WTRU is not reachable, and/or subscription update is required. In some embodiments, the message may be a NAS message.

According to certain embodiments, certain steps may be performed by an access and mobility management function (AMF). In one example, the AMF, on reception of a NAS message with new information element(s) providing information about the PEGC being unavailable and the PEGC being associated with a PIN ID, may pass on this information to a network exposure function (NEF) and may store the information in the WTRU's subscription information in the UDR. On reception of the information that the PEGC is unavailable from the WTRU, the AMF, which is aware of the identity of a WTRU that serves as the PEMC of the PIN, will trigger the downlink NAS signaling (e.g., WTRU Configuration Update Command, DL NAS Transport) toward the PEMC to inform the PEMC about the unavailability of the PEGC (i.e., Including new IE, PEGC Unavailable, PIN ID). The AMF may know the identity of the PEMC based on the subscription information from the UDM.

In some embodiments WTRU policies may be configured. As one example, a policy control function (PCF) may provide the WTRU with one or more WTRU policies. The PCF may provide each WTRU policy using one or more WTRU policy sections, each identified by a user equipment policy section identifier (UPSI) referencing rules for PDU sessions and network slices for a given service or application referred to as user equipment route selection policy (URSP). URSP Rules are a type of WTRU policy.

According to certain some embodiments, when traffic is initiated by a WTRU Application, the WTRU uses URSP Rules to determine the desired characteristics for the PDU Session that will carry the application traffic. An example of characteristics of a PDU Session are the data network name (DNN), single network slice selection assistance information (S-NSSAI), and session and service continuity (SSC) Mode that is associated with the PDU Session.

The URSP rule is a policy that may be used by the WTRU to determine how to route outgoing traffic. Traffic can be routed to an established PDU Session, can be offloaded to non-3GPP access outside a PDU Session, can be routed via a ProSe Layer-3 WTRU-to-Network Relay outside a PDU session, or can trigger the establishment of a new PDU Session.

Each URSP rule consists of two parts. The first part of the URSP rule is a Traffic descriptor that is used to determine when the rule is applicable. A URSP rule is determined to be applicable when every component in the Traffic descriptor matches the corresponding information from the application. The second part of the URSP rule is a list of Route Selection Descriptors (RSD). The list of Route Selection Descriptors contains one or more Route Selection Descriptors. The RSDs are listed in priority order and describe the characteristics of a PDU Session that may be used to carry the uplink application data. Characteristics of a PDU Session include SSC Mode, DNN, and S-NSSAI. The RSD may alternatively include a Non-Seamless Offload indication that indicates that the traffic may be sent via non-3GPP access (e.g., WiFi) and outside of any PDU Session.

For every newly detected application the WTRU evaluates the URSP rules in the order of Rule Precedence and determines if the application matches the Traffic descriptor of any URSP rule. When a URSP rule is determined to be applicable for a given application, the WTRU will select a Route Selection Descriptor within this URSP rule in the order of the Route Selection Descriptor Precedence.

When a valid Route Selection Descriptor is found, the WTRU determines if there is an existing PDU Session that matches all components in the selected Route Selection Descriptor. When a matching PDU Session exists, the WTRU associates the application to the existing PDU Session, i.e. the WTRU routes the traffic of the detected application on this PDU Session. If none of the existing PDU Sessions matches the RSD, the WTRU tries to establish a new PDU Session using the values specified by the selected Route Selection Descriptor.

If the RSD include a Non-Seamless Offload indication, then the WTRU will attempt to use a WLAN access network to transmit the data outside of any PDU Session. WLANSP rules may have been used to select the WLAN Access network.

Once traffic from an application is associated with a PDU Session, an event may cause the WTRU to re-evaluate the URSP rules and associate the traffic from the application with a different PDU Session. Two examples of events that may trigger URSP re-evaluation are an implementation dependent re-evaluation timer and the WTRU establishing access to a Wi-Fi network that provides internet access without using the 5G System (i.e. Non-Seamless Offload becomes possible).

A Traffic Descriptor may be an Application Descriptor, an IP descriptor, a Domain Descriptor, a non-IP descriptor, a DNN, or connection capabilities. An IP descriptor may be a Destination IP 3 tuple(s) (i.e. a IP address or IPv6 network prefix, port number, protocol ID of the protocol above IP).

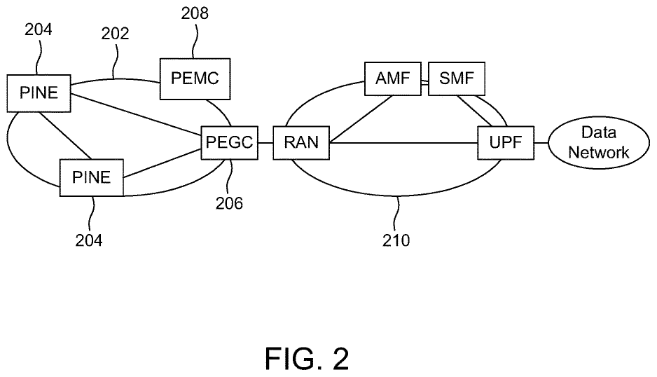

Referring to FIG. 2, an example Personal Internet of Things networks Architecture is shown. As briefly described above, a personal IoT network (PIN) 202 is a configured and managed group of PIN Elements 204 able to communicate with each other directly or via PIN Elements with Gateway Capability (PEGC) 206, communicate with 5G network 210 via at least one PEGC 206. A PIN 202 is managed by at least one PIN Element with Management Capability (PEMC) 208. A PIN element (PINE) 204 is any WTRU, UE or non-3GPP device that can communicate within a PIN 202 (via PIN direct connection, via PEGC 206, or via PEGC 206 and 5GC 210), or outside the PIN 202 via a PEGC 206 and the 5GC 210. A PIN Element with Gateway Capability (PEGC) is a PIN Element with the ability to provide connectivity to and from the 5G network for other PIN Elements, or to provide relay for the communication between PIN Elements. PIN Element with Management Capability (PEMC) 206 is a PIN Element with capability to manage the PIN.

Some Personal IoT Networks make the following architectural assumptions: (i) only a 3GPP WTRU can act as PEGC and/or PEMC; (ii) there are one or more PEGCs in a PIN; (iii) there are one or more PEMCs in a PIN, at any point of time one of which is able to control the PIN; (iv) the PIN Elements are assumed to use non-3GPP access (e.g. WIFI, Bluetooth) for direct communication, the PEMC can use 5G ProSe Direct Communication for direct communication with PEGC; (v) the PEGC and PEMC belongs to same PLMN or (S)NPN; (vi) a single PEGC may support more than one PIN at a time, and (vii) a multi-hop P2P (i.e. communication between a chain of PINEs) and P2N relay (i.e. communication from a PINE to another PINE or to the network via an intermediate PINE).

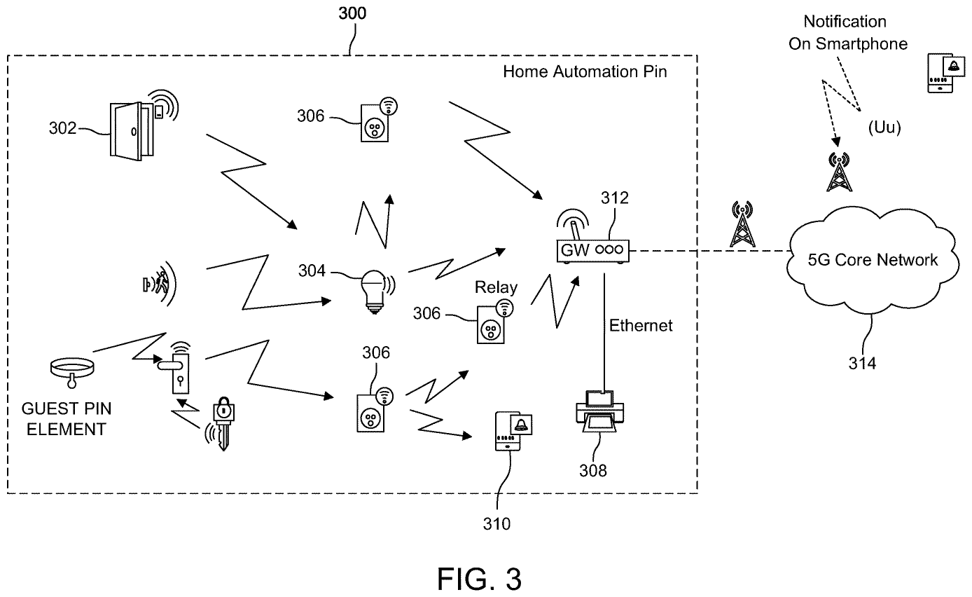

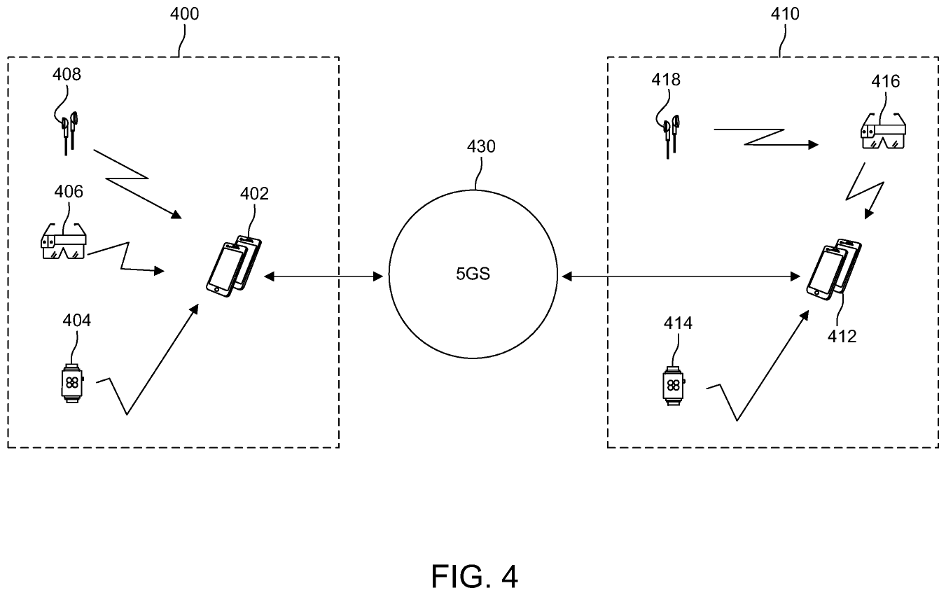

Referring to FIG. 3 and FIG. 4, examples of Personal Internet of Things networks (PINs) are shown. The Internet of Things (IoT) feature has been designed for devices that communicate using the traditional cellular network. Devices with IoT capabilities require better power consuming performance and increased the network efficiency for bulk operations.

When multiple IoT devices are deployed in a private environment, the WTRUs with IoT capabilities can be organized in a Personal IoT Network (PIN). For example, as shown in the home automation PIN 300 of FIG. 3, in a home environment, devices such as security sensor 302, smart light 304, smart plugs 306, printer 308, cellphone 310, etc. are managed by a residential gateway 312 and communicate with each other. In this case, all devices in the home constitute a Personal IoT Network (PIN) 300. Each of them is called a PIN element and different PIN elements have different capabilities. For example, a residential gateway 312 can be a PIN Element with Gateway Capability (PEGC) to provide connections between PIN elements and connections between 5G network 314 and PIN Elements. A PIN Element with Management Capability (PEMC) is a PIN Element that provides a means for an authorized administrator to configure and manage a PIN. A residential gateway which acts as a PEGC could support PIN management function as well and be a PIN element with management capability (PEMC).

As shown in the example PIN of FIG. 4, multiple wearable devices may also constitute another kind of PIN 402, 410, in which a smart phone 402, 414 may act as a PIN Element with Gateway Capability (PEGC) as well as a PIN element with management capability (PEMC) and smart watch 404, 414, VR/AR glass 406, 416, ear pieces 408, 418 that communicate with each other in the PIN (or with other WTRUs via 5G network 430).

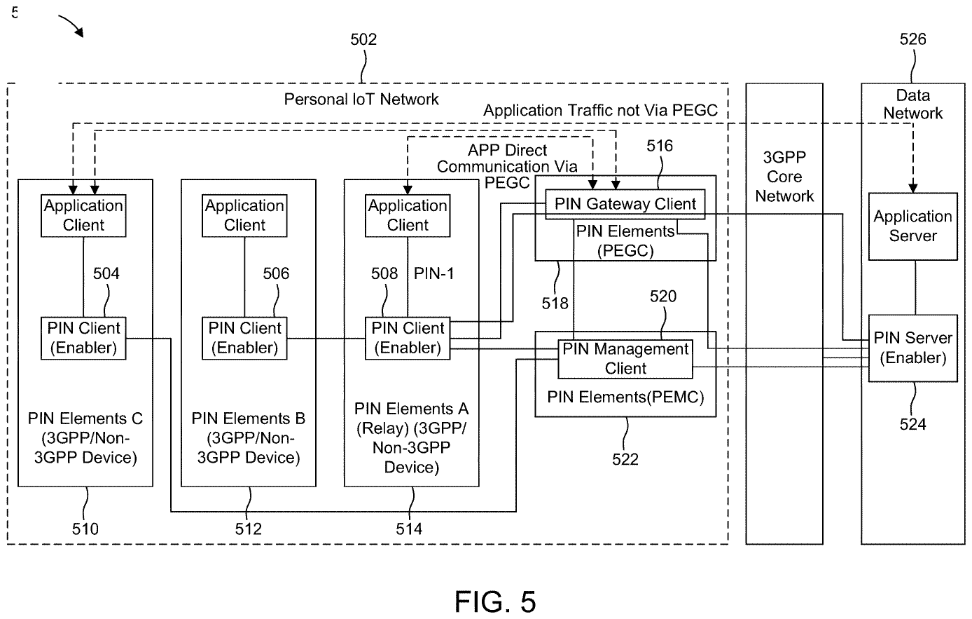

Referring to FIG. 5, an example PIN Application Framework (PINAPP) 500 is shown. A Personal IoT networks (PIN) 502 may also support application layer protocols and may be based on a PIN application layer functional model. An example application architecture 500 for enabling PINAPP is shown in FIG. 5.

It is important to note the application entities such as PIN Clients 504, 506, 508 in a PINEs 510, 512, 514, PIN Gateway Client(s) 516 in PEGC(s) 518, PIN Management Client(s) 520 in PEMC(s) 522, and/or PIN Server(s) 524 in data network(s) 526 may be part of the PINAPP architecture 500 and enable the desired features in a PIN. The embodiments described herein may interchangeably reference these functional entities and the PIN node, to enable a PINAPP feature.

A Registration Area (RA) is a set of tracking areas (i.e., a tracking area ID (TAI) List). The set of tracking areas includes tracking areas of any NG-RAN nodes in the Registration Area for a WTRU. When building an RA, the AMF may take into account various information (e.g., the WTRU's Mobility Pattern and Allowed/Non-Allowed Area).

The Mobility Pattern is a concept that may be used by the AMF to characterize and optimize the WTRU mobility. The AMF determines and updates Mobility Pattern of the WTRU based on subscription of the WTRU, statistics of the WTRU mobility, network local policy, and the WTRU assisted information, or any combination of this information. The statistics of the WTRU mobility can be historical or expected WTRU moving trajectory. If network data analytics function (NWDAF) is deployed, the statistics of the WTRU mobility can also be analytics (i.e., statistics or predictions) provided by the NWDAF. The Mobility Pattern can be used by the AMF to optimize mobility support provided to the WTRU, for example, Registration Area allocation.

A Requested NSSAI is an NSSAI provided by the WTRU to the Serving PLMN during registration. An Allowed NSSAI is a list Indicating the S-NSSAIs values the WTRU could use in the Serving PLMN in the current Registration Area.

A rejected S-NSSAI may also be called a “rejected slice.” The WTRU may receive a Rejected NSSAI from the AMF in a NAS message. A Rejected NSSAI is a list of rejected S-NSSAI's. In other words, the Rejected NSSAI is a list of rejected slices. The list of rejected slices may be sent to the WTRU in NAS messages such as Registration Accept, De-Registration Request, WTRU Configuration Update Command, or Registration Reject messages. Each Rejected S-NSSAI in the Rejected NSSAI is associated with a cause value that indicates why the AMF rejected the slice. The cause value is also used by the WTRU to determine the next time the WTRU is permitted to register to the rejected slice.

In some cases, the network may send to the WTRU a Rejected NSSAI for the current PLMN or SNPN which is a set of S-NSSAI(s) which was included in the requested NSSAI by the WTRU and is rejected by the AMF with the rejection cause “S-NSSAI not available in the current PLMN or SNPN”. If the network accepts the WTRU's registration request and the WTRU receives a Rejected NSSAI for the current PLMN or SNPN, the WTRU will not attempt to use this S-NSSAI(s) in the current PLMN or SNPN until switching off the WTRU, the UICC containing the USIM is removed, the entry of the “list of subscriber data” with the SNPN identity of the current SNPN is updated, or the network sends information to the WTRU indicating the S-NSSAI(s) are no longer considered rejected.

In some instances, the network may send to the WTRU a Rejected NSSAI for the current registration area which is a set of S-NSSAI(s) which was included in the requested NSSAI by the WTRU and is rejected by the AMF with the rejection cause “S-NSSAI not available in the current registration area”. If the network accepts the WTRU's registration request and the WTRU receives Rejected NSSAI for the current registration area, the WTRU will not attempt to use this S-NSSAI(s) in the current registration area until switching off the WTRU, the WTRU moving out of the current registration area, the UICC containing the USIM is removed, the entry of the “list of subscriber data” with the SNPN identity of the current SNPN is updated, or the rejected S-NSSAI(s) are removed or the network sends information to the WTRU indicating the S-NSSAI(s) are no longer considered rejected.

In other instances, the network may send to the WTRU a Rejected NSSAI for the failed or revoked network slice specific authentication and authorization (NSSAA), which is a set of S-NSSAI(s). The AMF may send the rejection with the rejection cause “S-NSSAI not available due to the failed or revoked network slice-specific authentication and authorization”. If the network accepts the WTRU's registration request and the WTRU receives an Rejected NSSAI for the failed or revoked NSSAA, the WTRU will not attempt to use this S-NSSAI(s) in the current PLMN or SNPN over any access until switching off the WTRU, the UICC containing the USIM is removed, the entry of the “list of subscriber data” with the SNPN identity of the current SNPN is updated, or the network sends information to the WTRU indicating the S-NSSAI(s) are no longer considered rejected.

In yet further instances, the network may send to the WTRU a Rejected NSSAI for the maximum number of WTRUs reached which is a set of S-NSSAI(s) included in the requested NSSAI by the WTRU. The rejection may be sent by the AMF with the rejection cause “S-NSSAI not available due to maximum number of WTRUs reached”. The network may also provide a backoff time value, called T3526, for each rejected slice. If the network accepts the WTRU's registration request and the WTRU receives an Rejected NSSAI for the maximum number of WTRUs reached, the WTRU will not attempt to use this S-NSSAI(s) in the current PLMN or SNPN over the current access until switching off the WTRU, the UICC containing the USIM is removed, the entry of the “list of subscriber data” with the SNPN identity of the current SNPN is updated, until the backoff timer expires, or the network sends information to the WTRU indicating the S-NSSAI(s) are no longer considered deleted.

In the above examples, when the WTRU receives a rejected slice, the WTRU is prevented from attempting to use (i.e., Register to) the slice again until some event occurs. For example, the event might be that the WTRU leaves the PLMN, leaves the RA, or when a back-off timer expires. This may be advantageous because it prevents the WTRU from repeatedly trying to register to a rejected slice. Thus, the WTRU is prevented from generating unnecessary signaling (i.e., attempts to register to a slice that are repeatedly rejected by the network).

As previously mentioned, the PEGC is a WTRU with subscription data related to a PIN associated with the 5GS, and may register to 5GS. A PEGC serving the PIN might not be able to serve the PIN because it may not be able to provide data connectivity to the external DN for various reasons discussed herein. The PEGC may not be able to service the pin because of an unsuccessful registration or because other NAS procedures were unsuccessful e.g., Session Management (SM) procedures such as PDU Session Establishment or Mobility Management (MM) procedures such as Registration or Service Request.

The procedures may be considered unsuccessful because due to the WTRU's reception of a rejection message from the network. Embodiments are described to handle the PIN elements traffic while the PEGC serving the PIN is rejected by the 5GS due to congestion or other causes, which make the PEGC unable to provide the data path for the PIN traffic.

Mechanisms and enhancements are described to address the scenarios where the PEGC providing the data connectivity to the PIN is rejected by the 5GS with congestion or other reject cause values, and ways this can be mitigated.

In certain embodiments the PEGC may trigger a deregistration procedure toward the 5GS and provide new information elements (IEs) that indicate the PEGC unavailability along with the PIN ID for the identification of the PIN. The AMF may pass on this information to the respective AF for the PIN, which on reception of PEGC unavailability, will trigger appropriate actions, e.g. PEGC relocation, re-configuring the PIN with different PEGC for service switch and continuity.

In another embodiment the AMF serving the PIN is aware of the PEGC's association with the PIN, through subscription information (or the SMF provides the subscription information about the WTRUs being associated with the PIN and/or is a PIN element with the gateway capabilities). The AMF, on detection of the unavailability of the PEGC because of various reasons (congestion/rejection etc.) may inform the PEMC associated with the PIN about the PEGC unavailability.

In another embodiment, the SMF, on rejecting or on becoming aware that PEGC is unable to serve the PIN, would inform the PEMC about the PEGC unavailability via NAS SM signaling, providing information via updated or new information elements.

The PEMC will take into consideration unavailability of the PEGC and trigger appropriate actions, such as reconfiguring the PIN with a new PEGC, service switch and continuity via the new PEGC, and inform the AF for the PIN via the User Plane about the re-configuration.

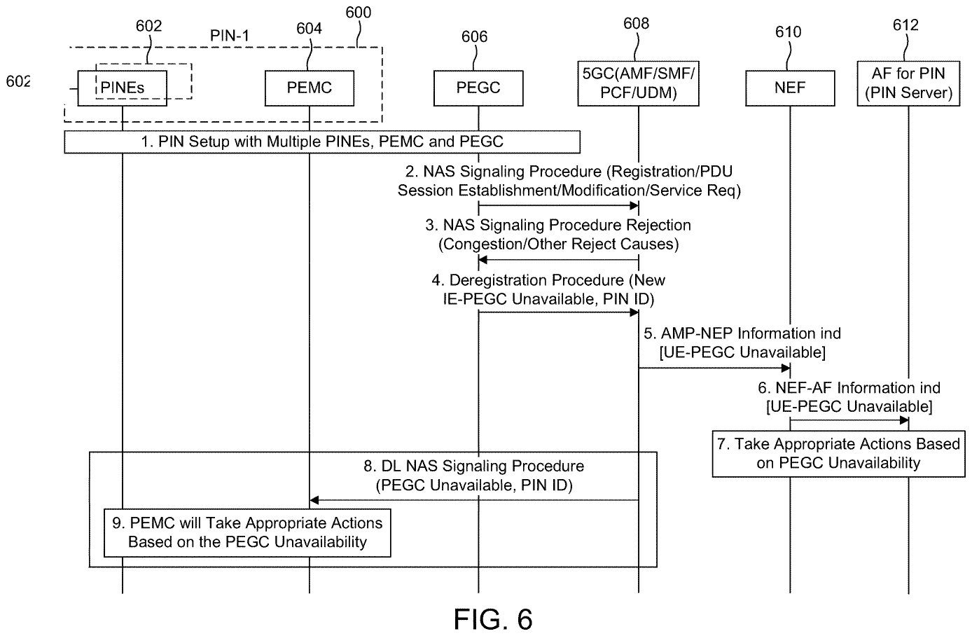

In reference to FIG. 6, embodiments for WTRU/AMF actions when a PEGC unable to serve the PIN are shown and described. As mentioned, the PEGC is the PIN element with the ability to provide connectivity to and from the 5G network for other PIN Elements, or to provide relay functionality for the communication between PIN Elements. PIN elements use the PDU session established by the PEGC for the UL data traffic to the external data network.

In one embodiment, as shown in FIG. 6, a method for a WTRU operating in a network may include, at Step 1. a PIN 600 is successfully setup with multiple PINEs 602, a PEMC 604 and one or more PEGC(s) 606. At Step 2. a trigger at the PEGC 606 has led the PEGC 606 to send a NAS signaling request to the AMF in 5GC 608. Example triggers could be Initial/Mobility/Periodic registration requests, Setup of the PDU session for the PINE traffic, Service request procedure to move the PEGC 606 from CM-IDLE to CM-CONNECTED state, etc.

In step 3, the AMF may reject the NAS singling request, due to, for example, congestion, maximum number of PDU sessions reached, insufficient resources for specific slice and DNN, insufficient resources for specific slice, insufficient user-plane resources for the PDU session, payload was not forwarded by the mobility management layer, network slice-specific authentication and authorization has failed or the authorization has been revoked, Partially rejected/allowed network slices, Rejected slices/requested slice is not part of allowed slices provided by the 5GS 608.

In certain scenarios e.g. congestion, the AMF might provide the PEGC 606 with the backoff timer where in the PEGC 606 is not allowed to initiate UL NAS signaling for normal services with exceptions including high priority services, emergency services or deregistration procedure. In another use case, the AMF could update the allowed NSSAI information to the PEGC which would lead to certain slices being used/desired by the PEGC as not valid anymore i.e. not part of the allowed NSSAI list.

In an alternate embodiment, on reception of the reject cause from the 5GS 608 at Step 3, the PEGC 606 may behave alternatively. Examples include on reception of the reject cause that indicates congestion, the usual behavior is that WTRU is backed off by the network with the backoff timer value, and while the back off timer is running the WTRU is not allowed to access the network for normal services and may continue with the normal cell reselection. Alternatively, that restriction is specifically removed for the WTRU (PEGC) and on reception of the congestion cause, it triggers the PLMN/SNPN selection to find other available and suitable PLMN/SNPN which are not congested.

In a scenario where a particular slice is rejected/not valid anymore, the PEGC may trigger slice specific PLMN selection using the slice-based prioritized PLMNs and try to find an available and suitable PLMN which does support the rejected/desired slice.

In a scenario where a particular slice is rejected or removed from the Allowed NSSAI, and the PEGC does not have the slice based prioritized PLMNs provided by the home network, new WTRU assistance information may be created (providing desired/rejected slices information), and sent to the home network requesting a slice-based prioritized PLMNs list. The home network may use the PEGC provided WTRU assistance information to generate a slice-based prioritized PLMNs list and provide the list to the PEGC via NAS signaling (e.g., SoR/DL NAS Transport). The PEGC may use newly received information to find an available and suitable PLMN supporting the rejected/desired slice.

At Step 4. the PEGC 606, on reception of the reject message from the AMF, triggers a DEREGISTRATION procedure toward the AMF. The PEGC 606 may provide new information elements (IEs) that indicate that the WTRU is a PEGC, that the WTRU will be unavailable, and a corresponding PIN Identification (PIN ID). The newly defined information element or information elements, will inform the AMF that the WTRU being rejected is a PEGC serving a particular PIN identified by PIN ID.

Alternatively, the NAS message that carries the new information elements may be a De-Registration message. In another embodiment, the NAS message that carries the new information elements may be a PDU Session Release message that is associated with the PDU Session that serves the PIN. In another example, the NAS message that carries the new information elements may be a Registration and the Requested NSSAI of the Registration message may not include the S-NSSAI that is associated with the PDU Session that serves the PIN. Alternatively, the NAS message that carries the new information elements may be an UL Transport message.

In various embodiments, the message that carries the new information elements may be triggered by: (i) reception of a NAS message with a rejection cause code; (ii) local configuration (e.g., a user configures the WTRU to indicate that it should no longer serve—the PIN or act as a PEGC); (iii) leaving a geographical area that is associated with the PIN, or (iv) entering a geographical area that is not associated with the PIN.

In various embodiments, the newly defined information elements may indicate one or more of: a reason that the WTRU can no longer act as a PEGC for the PIN (e.g., an indication what triggered the message); how long the WTRU is expected to be unavailable to server the PIN (e.g., this may be based on back-off timer value that was receive from the network); the identity of the PIN that the WTRU can no longer act for as a PEGC; an indication of whether or not the WTRU will continue to act as a gateway for routing local traffic in the PIN; a duration indicating how long the WTRU will continue to act as a gateway if the WTRU indicates continuing as a PEGC; and/or a type of service, e.g. mission critical, streaming, multimedia, interactive etc., along with respective status such as active/paused/inactive.

At Step 5. the AMF, on reception of the deregistration message with new information element(s) providing information about the PEGC being unavailable along with the PIN ID, will pass on this information to the NEF 610 or will store the information in the WTRU's subscription information in the UDR. The AMF may relay this information to SMF and the SMF may release the associated PDU sessions, and may invoke a service operation to request to the delete the session management (SM) policy association with the policy control function (PCF). The SMF may know that the PDU Session was being used to serve a PIN, as well as know that the PDU Session was serving a PIN based on information that the SMF received from the WTRU's subscription information from the UDM/UDR. For example, the Service specific information in the WTRU's subscription information may include an indication that a DNN/S-NSSAI combination serves a PIN. Based on the fact that the PDU Session was serving a PIN and based on the fact that the PDU Session is being released, or backed-off, the SMF may send a notification to the NEF or to the UDM/UDR that the PEGC is unavailable.

At Step 6. the NEF 610 may relay the information received from the 5GS 608 to the AF 612 for the PIN. Note that the notification sent to the NEF 610 to inform the NEF that the WTRU is not available to serve the PIN may alternatively come from the UDM/UDR.

In Step 7. the AF 612 for the PIN will take into consideration the unavailability of the PEGC 606 as provided by the 5GS 608, and take appropriate actions. Such actions may include reconfiguring the PIN with a new PEGC, service switch and continuity via the new PEGC, and instruct the PEMC over the user plane to trigger PEGC discovery and selection.

At Step 8., alternatively, on reception of the information that the PEGC 606 is unavailable from the WTRU, the AMF, which is aware of the PEMC 604 based on the subscription information from the UDM, will trigger the downlink NAS signaling (e.g., WTRU Configuration Update Command, DL NAS Transport) toward the PEMC informing about the unavailability of the PEGC (i.e., including new IE, PEGC Unavailable, PIN ID).

In Step 9. the PEMC 604 will take into consideration unavailability of the PEGC 606 and take appropriate actions. Such actions may include: discovering a replacement PEGC, notifying PINE(s) of PEGC unavailability, reconfiguring the PIN with a new PEGC, service switch and continuity via the new (e.g., replacement) PEGC, and/or inform the AF 612 for the PIN via the User Plane about the re-configuration.

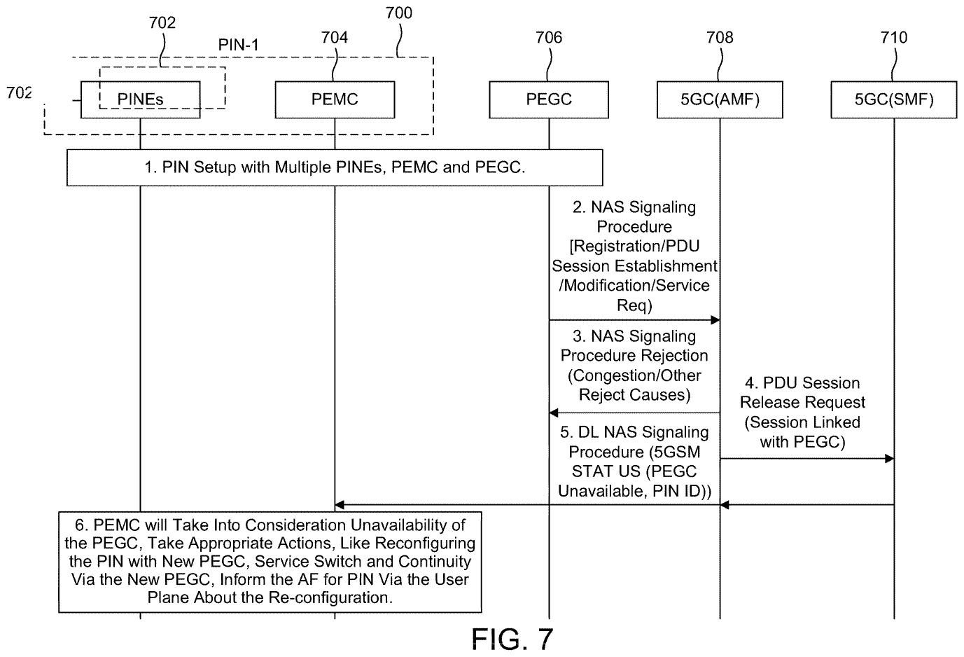

In reference to FIG. 7, embodiments of a service management function (SMF) 710 handling a PEGC 706 unable to service a PIN 700 will be described. As before, the PEGC 706 is the PIN element with the ability to provide connectivity to and from the 5G network for other PIN Elements 702, or to provide relay functionality for the communication between PIN Elements 702. PIN elements use the PDU session established by the PEGC f706 or the UL data traffic to the external data network.

At Step 1. a PIN 700 is successfully setup with multiple PINEs 702, a PEMC 704 and a PEGC 706. At Step 2.a trigger at the PEGC 706 causes the PEGC 706 to send a NAS signaling request to the AMF 708. Example triggers could be Initial/Mobility/Periodic registration requests, setup of the PDU session for the PINE traffic, service request procedure to move the PEGC from CM-IDLE to CM-CONNECTED state, etc.

In Step 3. the AMF 708 has rejected the NAS singling procedure, possible reject cause could be e.g. congestion, maximum number of PDU sessions reached, insufficient resources for specific slice and DNN, insufficient resources for specific slice, insufficient user-plane resources for the PDU session, payload was not forwarded by the mobility management layer, network slice-specific authentication and authorization has failed or the authorization has been revoked, Partially rejected/allowed network slices, Rejected slices/requested slice is not part of allowed slices provided by the 5GS. In certain scenarios e.g. congestion, AMF 708 would provide the PEGC 706 with the backoff timer where in the PEGC 706 is not allowed to initiate UL NAS signaling for normal services, exception include high priority services, emergency services or deregistration procedure. In another use case, the AMF 708 could update the allowed slices information to the PEGC 706, which would lead to certain slices being used/desired by the PEGC 706 as not valid anymore.

At Step 4., after rejecting the PEGC 706, the AMF 708 may invoke the Nsmf_PDUSession_ReleaseSMContext service operation to request the release of the PDU session at the SMF 708 and delete the SM context for the PEGC (WTRU).

In alternate embodiments, assuming the AMF 708 is aware that the WTRU, which is about to be rejected, is a PEGC e.g., via AMF/SMF coordination, or via subscription information from the UDM or via WTRU providing this information during the registration procedure to the AMF, the AMF may first inform the SMF 710 about the request to release the PDU session associated with the PIN, which provides the opportunity to the SMF 710 to successfully provide PEGC unavailability information across the PIN (i.e. to other PEMC/PEGCs) and subsequently the AMF 708 would send the control plane (CP) rejection to the PEGC 706.

At Step 5, the SMF 710, on reception of the PDU session release request from the AMF 708 for the PIN (the SMF is aware of the PDU session association with the PIN), will trigger the downlink SM signaling (e.g., 5GSM STATUS) toward the PEMC via the AMF (e.g. DL NAS Transport) informing about the unavailability of the PEGC (i.e. Including new IE, PEGC Unavailable, PIN ID). In the case there is no active ongoing PDU session established with the PEMC 706, the SMF 710 will first establish the PDU session and deliver the downlink SM message to the PIN. If the PIN is served by multiple PEGCs, the SMF 710 may inform other PEGCs as well, about the unavailability of the PEGC provided by the AMF 708. The SMF 710 may be aware of the PEMC 706 based on the PIN subscription information from the UDM and the PIN ID provided by the AMF 708 via the new information element.

At Step 6. the PEMC 704 will take into consideration unavailability of the PEGC 706, take appropriate actions, such as discovering a replacement PEGC, notifying PINE(s) 702 of PEGC unavailability, reconfiguring the PIN 700 with a new PEGC, service switch and continuity via the new (e.g., replacement) PEGC, inform the AF for PIN via the User Plane about the re-configuration.

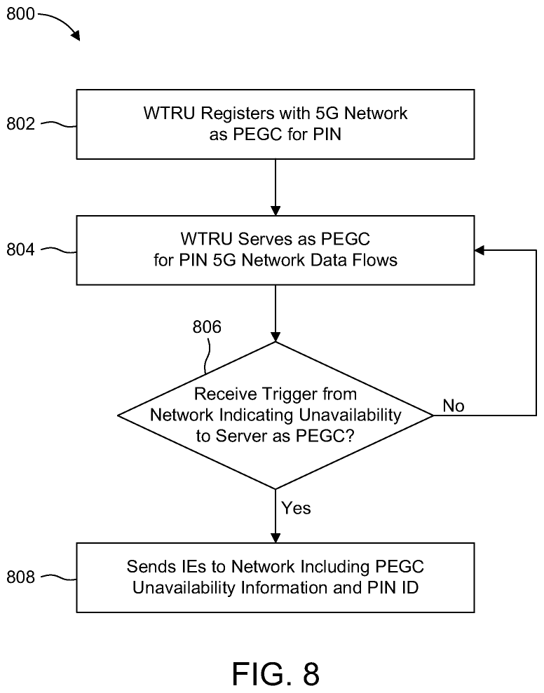

FIG. 8 is a flow diagram illustrating a method 800 for a WTRU managing PEGC unavailability to serve a personal Internet-of-things network (PIN) according to one example embodiment. At step 802, the WTRU associated with a PIN registers with the 5G network and establishes PDU sessions for the elements of the PIN. At step 804, the WTRU serves as a PEGC for data flows between the PIN and a 5G Network. For any of the various causes discussed previously, the network may determine the WTRU/PEGC connections/services to the network are unavailable and, at step 806, the WTRU receives NAS signaling procedure rejection, referred to as a “trigger.” In response, at step 808, the WTRU/PEGC may send new information elements (IEs) discussed previously, including PEGC unavailable information and a PIN ID. Depending on the reasoning for rejection, the WTRU may be deselected as a PEGC for the PIN, or sessions may be re-stablished if, for example a less congested PLMN/network slice can be configured. As discussed above, in one embodiment, a deregistration procedure may be triggered toward the network AMF, where the IEs indicate the WTRU is a PEGC, the WTRU will be unavailable and a corresponding PIN ID for network handling.

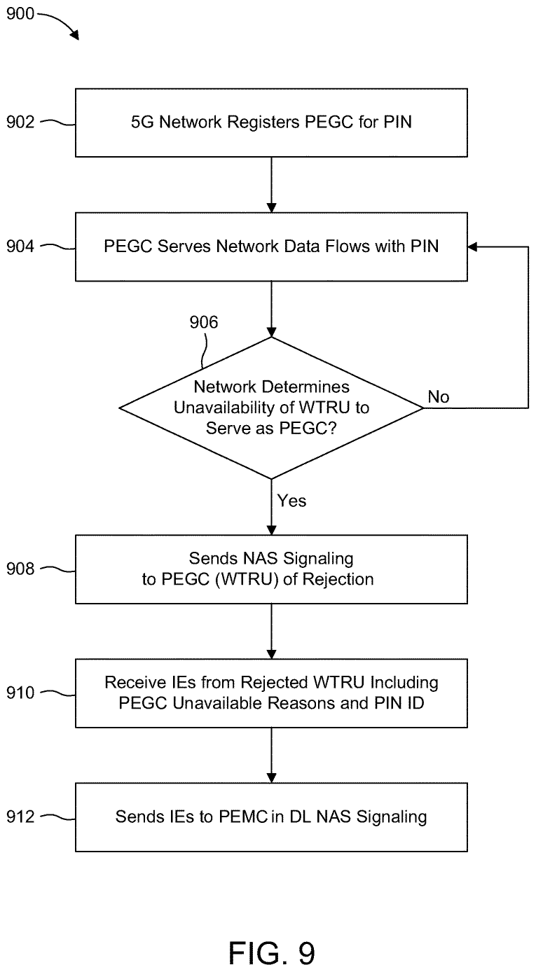

FIG. 9 is a flow chart showing a method 900 of network handling PEGC unavailability according to an embodiment. FIG. 9 describes steps performed at the network in connection with method 800 described above. At step 902, the 5G network registers the PEGC for the PIN. At step 904, the PEGC serves network data flows with the PIN. For any of the various causes discussed previously, at step 906, the network may determine the WTRU/PEGC connections/services to the network are unavailable and, at step 908, send NAS signalling to PEGC (WTRU) of rejection. At step 910, new information elements (IEs) discussed previously may be received from the WTRU/PEGC, including PEGC unavailable information and a PIN ID. Depending on the reasoning for rejection, the WTRU may be deselected as a PEGC for the PIN, or sessions may be re-stablished if, for example a less congested PLMN/network slice can be configured. In step 912, IEs are sent to the PEMC in DL NAS signalling.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for a wireless transmit/receive unit (WTRU) comprising:
registering as a personal Internet-of-things network (PIN) element with gateway capability (PEGC) with a wide-area wireless network (WWAN);
serving data flows between PIN elements and the WWAN;
receiving indication of unavailability of data flows with the WWAN; and
sending a non-access stratum (NAS) message including information elements to the network indicating a reason the WTRU can no longer act as PEGC for the PIN and a PIN identification (ID).

2. The method of claim 1, wherein the indication of unavailability is based on one of network congestion, maximum number of packet data unit (PDU) sessions reached, insufficient resources for specific network slice, insufficient user-plane resources, payload not forwarded by mobility management layer, and network slice authentication and authorization failure.

3. The method of claim 1, wherein the NAS message comprises one of a deregistration procedure message with an application management function (AMF), a PDU session release message, an uplink transport message, or a registration message that does not include single network slice selection assistance information (S-NSSAI) associated with a PDU session serving the PIN.

4. The method of claim 1, wherein the indication of unavailability is based on one of reception of a second NAS message including a rejection cause code or a local configuration change by a PIN element with management capability (PEMC).

5. The method of claim 1, wherein the NAS message including the information elements is triggered by leaving a geographical area associated with the PIN or entering a geographical area associated with the PIN.

6. The method of claim 1, wherein the information elements further comprise a time value indicating how long the WTRU may no longer act as the PEGC for the PIN, a time value indicating how long the WTRU is expected to be unavailable to serve the PIN, a duration indicating how long the WTRU will continue to act as the PEGC, or a type of service associated with the served data flows.

7. The method of claim 1, wherein the PEGC provides connectivity to and from the WWAN for one or more other PIN Elements.

8. The method of claim 7, wherein the one or more other PIN Elements use the PEGC to communicate with devices or servers that are outside of the PIN via the WWAN.

9. The method of claim 1, wherein the PEGC provides relay functionality for communication between other PIN Elements.

10. The method of claim 1, wherein a PEGC subscription includes data related to a PIN associated with the WWAN.

11. (canceled)

12. A wireless transmit/receive unit (WTRU) comprising:
a transceiver; and
a processor in communication with the transceiver, wherein the transceiver and the processor are configured to:
register as a personal Internet-of-things network (PIN) element with gateway capability (PEGC) with a wide-area wireless network (WWAN);
serve data flows between PIN elements and the WWAN;
receive indication of unavailability of data flows with the WWAN; and
send a non-access stratum (NAS) message including information elements to the network indicating a reason the WTRU can no longer act as PEGC for the PIN and a PIN identification (ID).

13. The WTRU of claim 12, wherein the indication of unavailability is based on one of network congestion, maximum number of packet data unit (PDU) sessions reached, insufficient resources for specific network slice, insufficient user-plane resources, payload not forwarded by mobility management layer, and network slice authentication and authorization failure.

14. The WTRU of claim 12, wherein the NAS message comprises one of a deregistration procedure message with an application management function (AMF), a PDU session release message, an uplink transport message, or a registration message that does not include single network slice selection assistance information (S-NSSAI) associated with a PDU session serving the PIN.

15. The WTRU of claim 12, wherein the indication of unavailability is based on one of reception of a second NAS message including a rejection cause code or a local configuration change by a PIN element with management capability (PEMC).

16. The WTRU of claim 12, wherein the NAS message including the information elements is triggered by leaving a geographical area associated with the PIN or entering a geographical area associated with the PIN.

17. The WTRU of claim 12, wherein the information elements further comprise a time value indicating how long the WTRU may no longer act as the PEGC for the PIN, a time value indicating how long the WTRU is expected to be unavailable to serve the PIN, a duration indicating how long the WTRU will continue to act as the PEGC, or a type of service associated with the served data flows.

18. The WTRU of claim 12, wherein the PEGC provides connectivity to and from the WWAN for one or more other PIN Elements.

19. The WTRU of claim 18, wherein the one or more other PIN Elements use the PEGC to communicate with devices or servers that are outside of the PIN via the WWAN.

20. The WTRU of claim 12, wherein the PEGC provides relay functionality for communication between other PIN Elements.

21. The WTRU of claim 12, wherein a PEGC subscription includes data related to a PIN associated with the WWAN.
